(19) United States
(12) Patent Application Publication
(10) Pub. No.: US 2009/0150428 A1
(43) Pub. Date: Jun. 11, 2009

(54) Data Management Method and System

(75) Inventors: Janne Anttila, Espoo (FI); Jari Eramaa, Brussels (BE); Tomi Alanappa, Kirkkonummi (FI); Ville Peurala, Helsinki (FI)

Correspondence Address: BIRCH STEWART KOLASCH & BIRCH, PO BOX 747, FALLS CHURCH, VA, 22040-0747, US

(73) Assignee: ANALYSE SOLUTIONS FINLAND OY, ESPOO (FI)

(21) Appl. No.: 11/989,215

(22) PCT Filed: Jul. 20, 2006
(86) PCT No.: PCT/FI2006/000264

§ 371 Date: Apr. 30, 2008

(30) Foreign Application Priority Data
Jul. 22, 2005 (FI) 20050779

(51) Int. Cl. G06F 7/00; G06F 17/30

(52) U.S. Cl. 707/102; 707/103 R; 707/E17.055; 707/E17.044

(57) ABSTRACT

In an information management method according to the present invention, objects connected with classification data are classified into trees so that criteria are defined for different branches of the tree, and objects are classified into the tree branches on the basis of these criteria. The method is primarily characterised in that a classification graph is defined between the objects and the trees, comprising of a network of classification data used to define the dependencies between the classification data. The invention also relates to an information management system and computer program which implement the said method.

### FIELD OF THE INVENTION

The present invention relates to a method and system for managing and organising information, as well as a computer program that implements the present invention.

### TECHNICAL BACKGROUND

The rapid development of information technology has made the collection of extensive amounts of data easier. Applications are required in several fields, such as for administering different kinds of registries and monitoring events. However, compressing the compiled results into information and understanding that is useful to users is a challenge.

In data processing, metaphors are often used as terms to make it much easier to understand the process of data processing. In a computer, files are stored in folders and libraries, for example. A tree is an example of a graphic metaphor.

Typically, the challenge is to classify the information into several different trees. Manual classification is a natural solution if there is only a single tree. A second tree doubles the amount of work. A third tree increases the amount of work by as much as the addition of the second tree, etc. Manual classification is laborious if there are many objects and trees to sort.

Grouping into trees may also be done with the help of classification data. An object is a basic concept and denotes a concrete thing in the real world or an abstract phenomenon. It is possible to connect classification data to an object and utilise it in trees. Classification data could include colour and shape, for instance. Corresponding criteria are defined for the tree e.g. so that blue objects are placed in one branch, red ones in another and objects of all other colours are classified into the third branch. Sub-branches could, for instance, be classified according to shape.

This solution works well if there are a limited number of classification data and their contents are the same for all objects, which means that the trees may also be based on these classification data. Other trees may be constructed similarly, using the same classification data. Classifying objects according to a new tree is relatively easy, as there is no need to process the objects manually.

Problems arise when all objects cannot be defined using the same classification data. For instance, if the second object is yellow, gaseous and poisonous, while the adjectives fast, elastic and circular would best describe the third object. Obviously, other kinds of classification data would be required for these objects than for the object in the example above.

Sorting objects into trees on the basis of classification data is a natural way of progressing when there are several trees, as an increase in the number of trees does not increase the amount of work in proportion.

However, the difference of the objects is a problem: uniform classification data might not necessarily be a natural solution for differing objects.

### OBJECTIVE OF THE INVENTION

The objective of the present invention is a method and system to manage information where classifying objects into trees is practical in spite of differences between the objects and a large number of trees.

### DESCRIPTION OF THE INVENTION

In an information management method in accordance with the present invention, objects connected with classification data are classified into trees so that criteria are defined for different branches of the tree, and said objects are classified into the tree branches on the basis of these criteria. The method is primarily characterised by the fact that a classification graph is defined as an interface between the objects and the trees. The classification graph is comprised of the network of classification data used to define the dependencies between the classification data. The invention also includes an information management system and a computer program which implement the method.

Objects are sorted into trees in an automatic process, after classification data have been defined for the objects in accordance with the classification graph, as well as classification criteria for different branches of the tree.

The invention may be used for managing the sorting of different products, for example.

The characteristic features of the preferred embodiments of the invention are set forth in the dependent claims.

The following terms are used in this document:

Father Node

Of two nodes connected by an arc in a directed tree, the node from which the arc originates and leads to the other node is called the father node (or senior node). In a directed tree, each node has one and only one father node, except for the root node, which has no father node. There may be several father nodes in a network.

Root Node

The root node is the first node of a tree or a network. In a directed tree, only the root node has access to all nodes in the tree.

Arc

An arc connects two different nodes in a tree (or a network). An arc may be either directed or non-directed.

Child Node

Of two nodes connected by an arc in a directed tree, the node to which the arc leads is called the child node. Apart from the root node, all nodes in the tree are child nodes of some other node. A node may have several children.

Leaf

A node without any children is a leaf.

Classification criterion A classification criterion may consist of a given number of classification data and their values. In addition to this, parentheses, clauses, various kinds of operators (such as “and”, “if”, or “all”) or any other criteria may be used in constructing the classification criteria.

Classification Graph

A classification graph refers to a directed network comprised of dependencies between classification data, and is a variation of a Directed Acyclic Graph network with no loops. Classification data make up the nodes of the network, Internodal dependencies are shown as arcs, and they can be either compulsory or optional. A classification graph is universal, i.e. it is independent of classification trees and objects. In other words, a classification graph is a kind of an interface, or a description of how the classification data are mutually dependent.

Classification tree A classification tree refers to one way of combining classification criteria into a tree structure so that after this connection objects may be placed in the tree automatically by comparing classification criteria in the tree branches with the classification data defined for the object.

Classification Data

Classification data is a property to which a certain value group may also be connected. In defining classification data for an object, both classification data and their values are usually attached to an object.

Object

An object refers to anything that can be classified into different kinds of trees as set forth in this document.

Tree A tree is a network with no loops. All nodes in a tree have one and only one father node, apart from the root node. A rooted tree is a tree with a specified originating node. Rooted trees are often used as information structures, making the network directed (even if no arrows are drawn in between). The depth of a rooted tree is the number of arcs in its longest path.

The method according to which the objects are classified is the most important thing in the present invention. The number of objects may be very high, and they can be dynamically classified into several trees of very different shapes. The idea behind the invention is to carry out the classification of objects into trees by using a classification graph as the interface between the trees and the objects. In defining the object, the trees into which objects will be subsequently placed do not have to be known. Correspondingly, when defining trees, the objects to be placed in the tree need not be known. In both cases it is enough to know the classification graph, i.e. the interface between the trees and the objects. The object classification process has four separate phases:

1. Definition of the classification graph

2. Definition of classification data for the objects in accordance with the classification graph

3. Defining tree hierarchies and tree classification criteria in accordance with the classification graph

4. Classifying objects into the tree hierarchy

Phases 2 and 3 may also be carried out in a different order (first phase 3 and then phase 2). This method may also be used so that the classification graph, number of classification data, number of objects, or tree hierarchies are changed, for example by expanding them as required.

1. Definition of the Classification Graph

The classification graph is used to define the mutual dependencies between the classification data. Dependencies make it possible to minimise the number of classification data defined for an object, and also to ensure that the required classification data are defined for each object. Defining trees in accordance with the classification graph makes it possible to guarantee that there will be no objects that do not belong to any of the leaves in the tree. This makes it possible to define the simplest possible criteria for the classification.

2. Definition of classification data for objects takes place in accordance with the classification graph The desired number of classification data and their values are defined for the object.

3. Defining Tree Hierarchies and Tree Classification Criteria in Accordance with the Classification Graph

The classification data of an object in a tree branch and their values must conform to the tree branch's and its father nodes' classification criteria.

4. Classifying objects into the tree hierarchy Placing objects in trees may be done in connection with every change or in batch processing. The classification is made on the basis of the objects' classification data into branches in the tree in accordance with the classification criteria.

A model makes it easy to classify an extensive number of objects into several different trees. The objects to be classified and the trees are separated by a classification graph, which acts as the interface. This makes the trees and objects dynamic, and adding or modifying them subsequently is easy. The use of an interface provides the following benefits:
The number of classification data to be defined for objects can be minimized, which makes the amount of definition work minimal, and makes it possible to classify very different objects.
The classification data defined for an object are characteristic of it, and thus also sensible to define.—It is possible to ensure that all required classification data have been defined for all objects.
It is possible to utilise shared classification data in the classification graph to the extent that the objects have them. On the other hand, it is possible to define other classification data without having to define them for objects to which they is not relevant.—Dynamic trees: when adding or modifying trees, it is not necessary to know the objects that will be placed in the trees; the trees are designed on the basis of the classification graph. This makes the trees dynamic and easy to add.—Dynamic objects: when adding objects to the system, it is not necessary to know the structure of the trees; it is enough to define the classification data for the objects in conformance with the classification graph. This makes it easier and faster to bring new objects into the system.

Below, the invention is described in more detail by referring to drawings and examples, which are not meant to limit the scope of the present invention; the images are examples of potential embodiments.

### DRAWINGS

FIGS. 1 to 4 show examples of how objects are defined in accordance with the classification graph.

FIG. 5 shows an example of an object and its classification data.

FIG. 6 shows the classification of the object from FIG. 5 into a tree.

FIG. 7 presents the classification of the object from FIG. 5 into a more extensive tree.

FIGS. 8 to 15 present a practical example. FIG. 8 presents the colour coding of classification data.

FIG. 9 presents the classification data of the example.

FIG. 10 presents the classification data defined for the first product example.

FIG. 11 presents the classification data defined for the second product example.

FIG. 12 presents an example image of the definition of an object's classification data.

FIG. 13 presents an example of a product tree constructed in accordance with the characteristics of the product examples.

FIG. 14 presents a product tree where the product examples are classified according to packaging type.

FIG. 15 is an example of the classification of the product tree's classification criteria.

### DETAILED DESCRIPTION

The classification graph is a directed network that expresses the mutual relationships between different pieces of classification data. These relationships are used when defining classification data for an object or classification criteria for trees.

Different kinds of classification data may be given differing data types as values, but a single classification data is always of the same data type. For instance, the classification data value may be a decimal number, Boolean (yes/no) value, multiple choice, character string or an integer.

The definition of objects refers to the attachment of classification data to an object. These are subsequently used when classifying objects into trees. Classification data are defined for the objects based on the classification graph so that all and only the classification data with arcs leading to them from the classification data set for the object should be set for the object. The starting point is in the root nodes, as this is the only way to be certain of all the classification data set. It should be noted that in addition to the classification data, their values are also attached to the object.

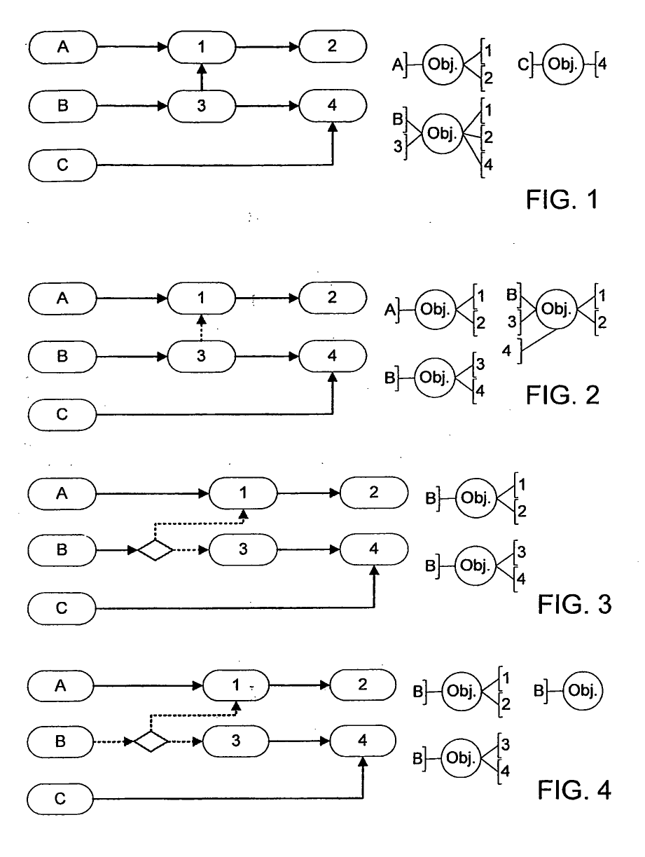

FIG. 1 shows an example of a classification graph where all arcs, i.e. mutual relationships between the classification data, are unconditional, which is depicted by representing the relationship between classification data A, B, C, 1, 2, 3 and 4 with a solid arrow. The letters depict root nodes. An unconditional arc means that the arc must be followed, which makes the classification data in the arc's child node compulsory for the object.

In this classification graph, classification data may be defined for objects in the following way, for instance:
Classification data A is defined for the object. As a consequence, classification data 1 and 2 must also be defined for the object in question. This is shown in the left upper figure depicting object definition.
Classification data B is defined for the object->classification data 3, 1, 2 and 4 must also be defined. This is shown in left lower figure depicting object definition.
Classification data C is defined for the object->classification data 4 must also be defined. This is shown in the upper right figure depicting object definition.

FIG. 2 shows an example of a classification graph where one arc is conditional. In this case, it is not compulsory to follow the arc, and the classification data behind the conditional arc is not mandatory. A conditional arc is shown in FIG. 2 by drawing the arc between classification data 3 and 1 as a dotted line.

In the classification graph of FIG. 2, classification data may be defined for objects in the following way, for instance:
Classification data A is defined for the object. As a consequence, classification data 1 and 2 must also be defined for the object in question.

This is shown in the upper left figure depicting object definition.
Classification data B is defined for the object->classification data 3 and 4 must also be defined. It is possible to define classification data 1 for the object as well. In this case, one would have to also define classification data 2, as it is connected to classification data 1 with an unconditional arc. This is presented in the upper right figure depicting object definition.
Classification data B is defined for the object->classification data 3 and 4 must be defined, but classification data 1 has not been defined in this example, which is not compulsory due to its optional nature, as the arc between classification data 1 and 3 is a conditional one. This is presented in the lower figure depicting object definition.

FIG. 3 presents an example of a classification graph where one arc is branched. In this case, we only follow one optional branched arc and classification data related to it are defined. The branched arc has been illustrated in FIG. 3 by presenting the relationships of classification data B to classification data 1 and 3 so that either classification data 1 or 3 is mandatory, in which case the arc leads out from classification data B in the form of a solid arrow. On the way, it branches out into two arcs at the fork, from which a conditional arc goes to both classification data 1 and classification data 3. So, in FIG. 3, one must choose either classification data 1 or classification data 3. When classification data 1 is chosen, classification data 2 must also be chosen. Correspondingly, when one chooses classification data 3, classification data 4 must also be chosen.

The branched arc makes the branches optional. Only one of the arcs can be followed.

The branching point has been marked as a diamond in the figure.

In this classification graph, classification data may be defined for objects in the following way, for instance:
Classification data B is defined for the object. As a consequence, either classification data 1 or classification data 3 must be defined for the object. If classification data 1 is defined, classification data 2 must also be defined as a consequence. This is presented in the upper figure depicting object definition.—Correspondingly, defining classification data 3 requires the definition of classification data 4. This is presented in the lower figure depicting object definition. (Both classification data 1 and classification data may not be defined for the same object.)

FIG. 4 shows a conditionally branched arc. In this case, it is not necessary to select any of the classification data behind the branch, but one may be chosen. The conditionally branched arc has been shown in the form of a dotted arrow leaving classification data B. On the way, it branches out into two arcs at the branch point, from which a conditional arc goes to both classification data 1 and classification data 3. So, in FIG. 4, one may choose either classification data 1 and 2 or classification data 3 and 4 or no classification data besides B.

In this classification graph, classification data may be defined for objects in the following way, for instance:
Classification data B is defined for the object. As a consequence, either classification data 1 or classification data 3 may be defined for the object. If classification data 1 is defined, classification data 2 must also be defined as a consequence. This is presented in the upper left figure depicting object definition.
Correspondingly, defining classification data 3 requires the definition of classification data 4. This is shown in the lower figure depicting object definition. (Both classification data 1 and classification data may not be defined for the same object.))—It is also possible not to define either classification data 1 or 3, even if classification data B has been defined for the object, as the arc leading from classification data B to classification data 1 and 3 is conditional from the beginning. This is presented in the right upper figure depicting object definition. FIG. 6 shows an example of a three-branched tree with conditions. A tree with conditions is called a Classification tree. The depth and width of the tree's branches may vary freely. Consequently, the tree can be as wide or as deep as one likes, and the depths of its branches may vary.

The tree shown in FIG. 6 has an originating node on the left, and three leaf nodes A, B and C. Objects are meant to be classified into these leaf nodes on the basis of the classification data defined for the objects. The classification takes place in accordance with the criteria in the tree branches, as will be shown later.

Defining the tree refers to the definition of the tree's structure and its criteria. The tree's criteria are defined on the basis of the classification graph; it is not necessary for the user to know anything about the objects to be placed in the trees. It is better to use the classification data behind the compulsory (unconditional) or optional arcs of the classification graph in the criteria, as it is not necessary to define the optional (conditional) classification data for the object.

The object is placed into the trees on the basis of its classification data. Criteria comprise classification data and their values. The object is placed into the branch whose criteria it fulfils. The most natural thing to do is to begin the checking of the criteria at the root of the tree.

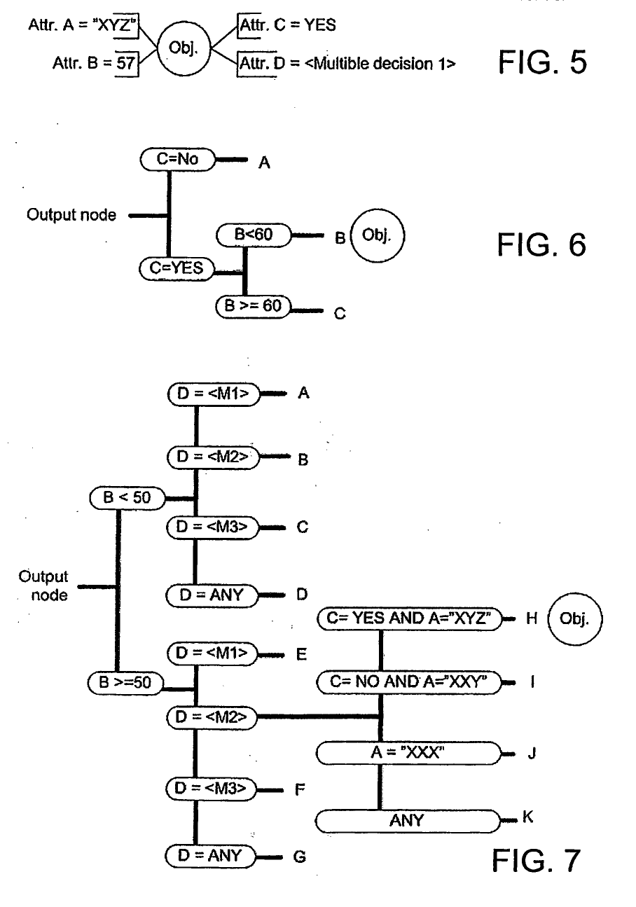

FIG. 5 shows an example of an object and its classification data It assumes that we have an object that fulfils the following classification data (A=“XYZ”, B=57, C=YES and D=<M2>).

The object shown in FIG. 5 is placed into different leaves in different trees based on its classification data and the trees' criteria. FIG. 6 shows the classification of the example object in FIG. 5 into a tree. In the example tree, the object is placed into leaf B, as the Object's classification data C value is “Yes” and the value of B is less than 60.

The criteria may be much more complicated than described above. A single criterion may include several classification data, and may use different kinds of operators, such as AND, OR, NOT and ANY. Other operators besides the ones mentioned above may also be used.

FIG. 7 shows the classification of the example object in FIG. 5 into another kind of a tree.

Here, according to the criteria, the object is placed into leaf H on the basis of its classification data. This example uses operators and conditional clauses that are more complicated than those in the previous example.

When trees are used, their criteria and the object's classification data may be removed, as different branches may be named as something easily understood by the user. Normally, we are only interested in knowing into which leaves of various trees each object is placed. The naming does not need to be directly connected with the criteria used, but in practice there is an obvious correlation.

As many trees and objects may be created as desired. All objects can be placed into trees on the basis of the rules presented above, as long as the boundary conditions are met:
The classification data contained in the criteria of the tree branches to which the object belongs must be defined for the object. Not all of these classification data are necessary, as some of the classification data may be mutually exclusive, such as with the operators OR and ANY. The classification data required by the object are defined on the basis of the classification graph.—The tree's criteria must be adequately specified and mutually exclusive. Otherwise, a situation may arise where a single object could belong to several different leaves or to no leaves at all.

### A PRACTICAL EXAMPLE

For instance, sales reporting between manufacturers and central firms may be based on daily sales data from points of sale provided by the central firms. The information is collected and prepared for further reporting. Information about products is required as background for sales data reporting. Products must be classified into tree hierarchies as requested by customers.

In this example, by using a method in accordance with the present invention, products (beer and soft drinks) are classified into product trees for reporting. The method makes it possible to classify the products in a flexible and effective way.

The following is a step-by-step description of the object classification process.

1. Definition of the Classification Graph

It is convenient to begin the product classification with the design of the classification graph. The classification graph consists of classification data and arcs joining them.

An arc may be either mandatory or optional. A mandatory arc is shown as a solid line and a voluntary arc as a dotted line in the figures. An arc may also split into two or more branches.

With regard to the classification data, its name and type are described in the classification graph. The value of the classification data is not defined in the graph. The name of the classification data can be anything, and the following data types have been used in the example graph: Boolean, multiple choice, integer and decimal number.

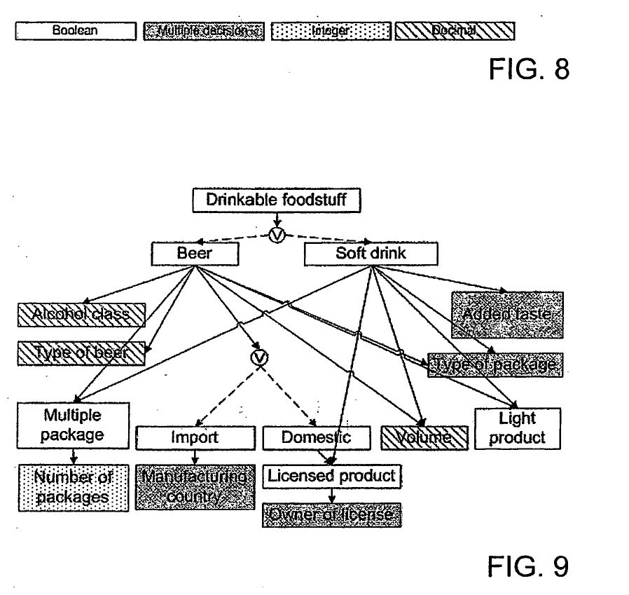

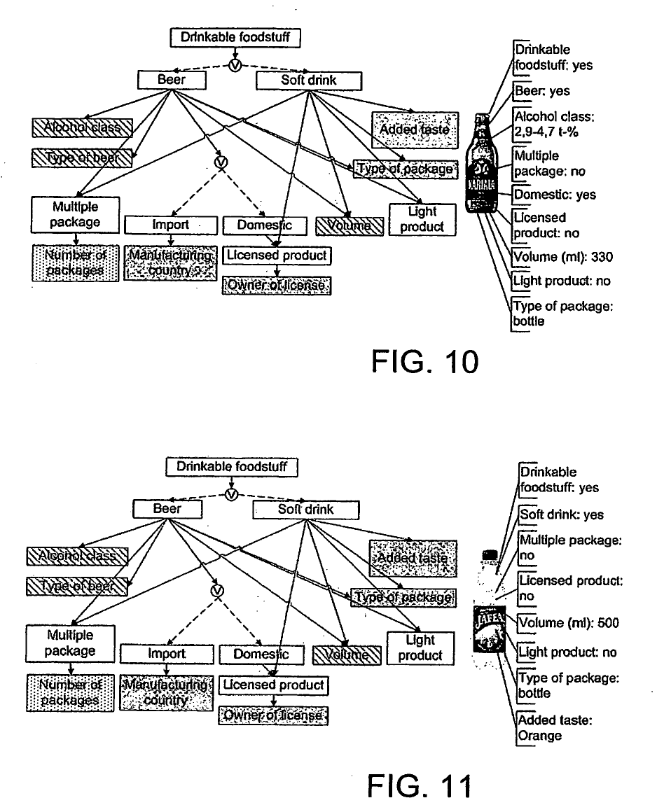

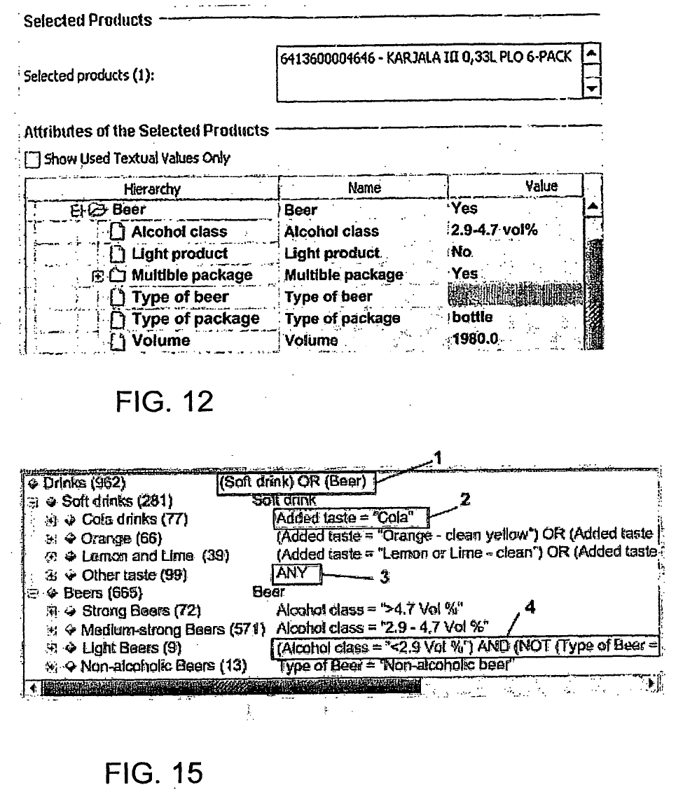

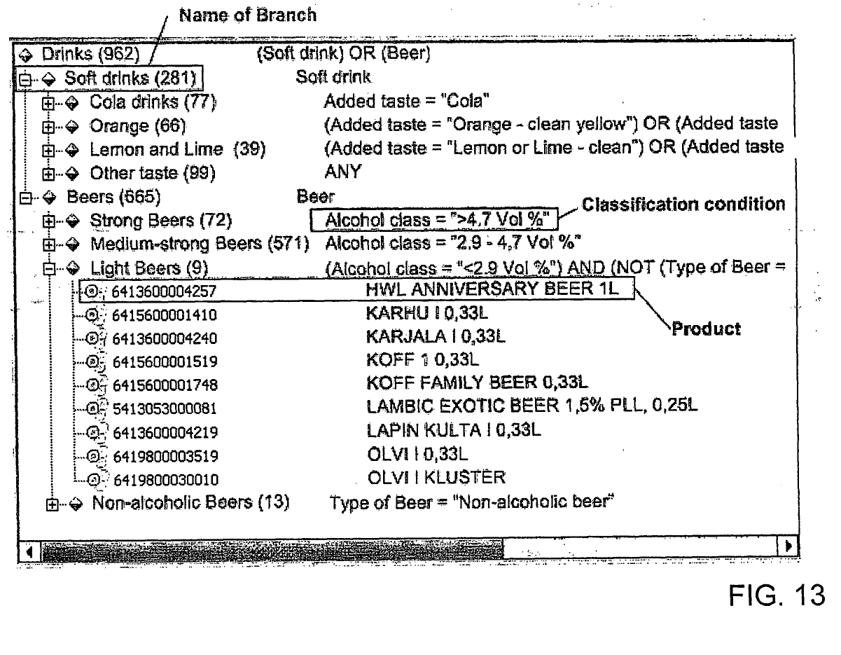

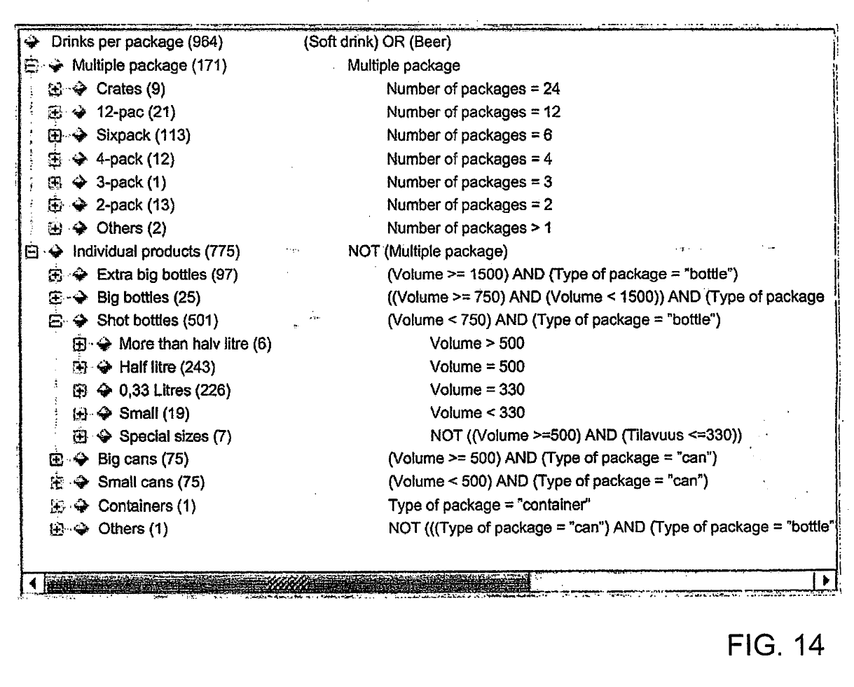

FIG. 8 presents the coding of the classification data. The Boolean type is shown as colourless, the Multiple choice type as grey, the Integer type as dotted and the Decimal type as striped.

Boolean classification data may have Yes or No as its value. It may also be blank if no value has been given. The multiple choice is one of several specified options, such as Hartwall, Olvi, Sinebrychoff etc. The classification data may also be a number, in which case it may be an integer or a decimal number, for instance.

The root node of the classification graph presented in FIG. 9 is Drinkable foodstuff classification data, which is Boolean, and its value can thus be yes or no. A branched arc goes from this classification data to all drinkable foodstuffs, which may include also other products than beer and soft drinks; however, to make the example simpler, they have been omitted. So, a drinkable foodstuff may not be both beer and a soft drink at the same time, but it must be one of the options given.

There are compulsory arcs going from the Beer classification data to the following classification data: Beer type, Alcohol content (alcohol class), Multi-pack, Volume, Light product and Packaging type. In addition, one branched arc goes from the Beer classification data. When the product is Beer, the aforementioned classification data must be defined for it, as well as a second classification data from behind the branch (Imported or Domestic), which are mutually exclusive.

Arcs corresponding to those going from the beer classification data go also from the soft drink classification data. However, alcohol class or beer type may not be defined for a soft drink; on the other hand, added_taste_soft drink is a property characteristic of a soft drink. Not much soft drink is imported into Finland in bottles, so the choice between Imported/Domestic needs not be made. Instead, a soft drink may be manufactured under license. Because of this, an arc goes directly to: licensed product. If the product is a licensed product, also a license holder must be defined for it, as a mandatory arc goes there.

The classification graph is used in setting classification data for the product. The user does not have to know anything about the trees used for classifying the products; it is enough for the user to follow the classification graph. In addition to the classification data, its value is also bound to the product.

Careful planning of the classification graph ensures that the smallest possible number of classification data needs to be set for products, while all required classification data are found for each product.

2. Definition of Classification Data for the Objects in Accordance with the Classification Graph

Setting the classification data is illustrated using two example products, the first one of which is a beer and the second one a soft drink.

Product 1: Beer

Drawing 10 presents the classification data defined for beer in this example.

The product presented in the example is a drinkable foodstuff. Due to the structure of the classification graph, it must be defined either as a beer or a soft drink. It is a beer, so yes is defined as the value of the classification data beer. As a consequence, the following data must be defined: alcohol class, beer type, multipack, volume, light product and packaging type. In addition, one must choose whether the product is domestic or imported. The product is defined as domestic, and thus one must also define whether it is also a licensed product. The product is not a licensed product, so the license holder does not need to be defined.

Product 2: Soft Drink Drawing 11 Presents the Classification Data Defined for a Soft Drink in this Example.

Classification data are set for the soft drink in the example similarly to beer. It should be noted that the classification data to be set are different from the previous example. For instance, alcohol content and beer type are not relevant for a soft drink. Correspondingly, the data added_taste_soft drink is defined for a soft drink, which is a property not found with beer. However, classification data are largely the same for the products. This is a benefit in classifying the products into product trees, as will be pointed out later.

In drawing 12, the user is asked only the classification data relevant for the product according to previous selections.

3a. Defining Tree Hierarchies and Tree Classification Criteria in accordance with the Classification Graph

Constructing the product trees comprises of two separate phases: the tree structure and the definition of the classification criteria. Tree structure refers to the subbranches and leaves in the tree. Classification criteria are defined for the branches of the product tree as well. For instance, one may define that all beers are classified into one branch and soft drinks into the second branch. Also more complicated criteria may be provided for a branch, such as “light 0.3 litre domestic beers”. Instead of natural language, Analyse Query Language (AQL) is used in constructing the criteria. This description has been developed by Analyse Solutions Finland Oy for the construction of classification criteria. It is important to note that the classification criteria are defined against the classification graph, and the products to be classified into the tree need not be known. The product trees can be of any depth, and the depths of different branches may differ.

Drawings 13 and 14 contain two examples of product trees. In the first product tree, beverages are classified according to their characteristics, and in the second product tree, according to packaging type and bottle size. There could be an almost infinite number of additional product trees, and all products can be classified into them automatically without having to know anything about the products.

The left side of the example drawing 14 shows the branches and leaves of the product tree and their names. The figure inside the parentheses shows the number of products in the branch in question, i.e. how many products fulfill the criteria shown at the right edge of the window. Opening the leaf level displays the products fulfilling the criteria. The right-hand side of the window displays the classification criteria.

The products previously presented in this document are placed into the branches Soft drinks/Orange drinks and Beers/Class III beers. In another kind of a tree, the products could end up in the same leaf or near to each other, such as in a tree classified by packaging type, as in drawing 14. In it, the products would be placed in the branches Single products/Single use bottles/0.5 litre and Single products/Single use bottles/0.33 litres. Using classification data shared by different products provides a very versatile and effective way of constructing product trees.

Definition of classification data always takes place against the classification graph. It is not necessary to know the products to be classified.

Drawing 15 is an example of the definition of classification criteria. The beverage tree depicted in the example will include the products that fulfill the criterion: (soft drink) OR (Beer) (see item 1), the criterion could just as well be the classification data Drinkable foodstuff.

Soft drinks are classified according to tastes by using the added_taste_soft drink classification data (see item 2). Those not chosen for other branches are collected to the branch other taste with the word ANY (see item 3).

Correspondingly, beers are classified according to the classification data alcohol class and beer type. Class IV beer has a slightly more complicated AQL clause.

Class I beers will include all products whose alcohol content is less than 2.9% but which are not non-alcoholic.

4. Classifying Objects into the Tree Hierarchy

Drawing 13 contains an example of a tree hierarchy into which objects are classified based on the rules. The objects, in this case foodstuffs, have been classified into the tree's branches to which they belong based on their classification data.

1. A method for the management of information, in which method objects are classified into trees so that classification criteria are defined for different branches of the tree, and objects are classified into the tree's branches based on these criteria, and classification data are attached to the said objects, wherein an interface is defined in between the objects and the trees, the said interface comprising of classification data and their mutual relationships.

2. The method of claim 1, wherein the classification data connected with the objects and the trees' classification criteria are defined in accordance with the interface.

3. The method of claim 1, wherein objects are classified into the trees by defining a) the interface between the objects and the trees, b) classification data for the objects, and c) hierarchies and classification criteria for the trees.

4. The method of claim 1, wherein objects are classified into the trees by defining a) the interface between the objects and the trees, b) hierarchies and classification data criteria for the trees, and c) classification data for the objects.

5. The method of claim 1, wherein the method is used so that the interface, classification data and/or their number, objects and/or their number and/or tree hierarchies and/or their number are changed as necessary.

6. The method of claim 1, wherein values are specified for the classification data.

7. The method of claim 1, wherein the relationships between the classification data contained by the interface are depicted in different kinds of arcs, which can be unconditional, conditional and/or branched.

8. The method of claim 7, wherein classification data are defined for the objects so that classification data to which an arc goes from the classification data set for the object are set for the object.

9. The method of claim 7, wherein classification data are defined for the objects so that all the classification data to which an arc goes from the classification data set for the object directly or via another classification data are set for the object.

10. The method of claim 7, wherein classification data are defined for the objects so that the desired number of classification data to which a conditional arc goes from the classification data set for the object are set for the object.

11. The method of claim 7, wherein classification data are defined for the objects so that additionally the desired number of classification data to which a conditional arc leads from a classification data set for the object, including the classification data from which an unconditional arc goes to the classification data set for the object via another classification data, and the desired number of classification data from which a conditional arc leads to a classification data set for the object via another classification data, is set for the objects.

12. The method of claim 7, wherein classification data are defined for the objects so that additionally classification data from which a branched arc goes to other classification data are set for the object.

13. The method of claim 7, wherein classification data are defined for the objects so that additionally classification data from which a branched arc goes to other classification data are set for the object.

14. The method of claim 7, wherein classification data are defined for the objects so that additionally classification data from which a branched arc goes to other classification data are set for the object and also the classification data at the end of either one of the branched arcs is/are defined for the object.

15. The method of claim 1, wherein the tree contains the desired number of hierarchical branches.

16. The method of claim 1, wherein a structure and classification data are defined for the tree, comprising of one or more classification and, if necessary, their values.

17. An information management system with objects classified into trees, which objects are classified into the tree's branches in accordance with these classification criteria, and where classification data are attached to the said objects, wherein there is an interface comprising of classification data and their mutual relationships between the objects and the trees.

18. The system of claim 17, wherein the classification data connected with the objects and the trees' classification criteria are compliant to the interface.

19. The system of claim 17, wherein the classification data have values.

20. The system of claim 19, wherein the tree structure contains the desired number of hierarchical branches, which contain classification criteria, comprised of one or more classification data and their values.

21. The system of claim 17, wherein the arcs depicting the relationships between the classification data contained by the interface are unconditional, conditional and/or branched.

22. The system of claim 21, wherein the objects have defined classification data to which an arc leads from the classification data set for the object.

23. The system of claim 21, wherein the objects have been defined with all the classification data to which an unconditional arc leads directly from the classification data set for the objects or via another classification data.

24. The system of claim 17, wherein the tree has a structure and criteria, comprising of classification data and their values.

25. A computer system implementing a method in which objects are classified into trees so that classification criteria are defined for different branches of the tree, and objects are classified into the tree's branches based on these criteria, and classification data are attached to the said objects, wherein an interface is defined in between the objects and the trees, the said interface comprising of classification data and their mutual relationships.
